(19) United States
(12) Patent Application Publication
(10) Pub. No.: US 2022/0038607 A1
(43) Pub. Date: Feb. 3, 2022

(54) HOUSING, REMOVABLE LENS, AND HOUSING SYSTEM FOR AN IMAGE CAPTURE DEVICE

(71) Applicant: GoPro,Inc, San Mateo, CA (US)

(72) Inventors: Jordan Todd, Piedmont, CA (US); Mathew David Thomas, Casro Valley, CA (US); Daniel J. Coster, Oakura (NZ); Bessy Liang, San Jose, CA (US); Huy Phuong Nguyen, Alpine, UT (US)

(21) Appl. No.: 17/444,020

(22) Filed: Jul. 29, 2021

Related U.S. Application Data
(60) Provisional application No. 63/059,648, filed on Jul. 31, 2020.

(51) Int. Cl. H04N 5/225; G03B 17/14; G03B 11/04

(52) U.S. Cl. CPC H04N 5/2252; G03B 11/043; G03B 17/14; H04N 5/2254

(57) ABSTRACT

A housing system for an image capture device includes a housing and a removable lens assembly. The housing is formed of an elastomeric material and defines a cavity for receiving the image capture device therein. The removable lens assembly includes a protective lens and is removably coupleable to the housing to protect a lens of the image capture device.

### CROSS-REFERENCE TO RELATED APPLICATION(S)

This application claims priority to and the benefit of U.S. Provisional Application No. 63/059,648, filed Jul. 31, 2020, the entire disclosure of which is incorporated by reference herein.

### TECHNICAL FIELD

This disclosure relates to image capture devices and, in particular, to housings for image capture devices.

### BACKGROUND

Image capture devices (e.g., cameras) may be used in environments and use cases in which the image capture devices and components thereof are susceptible to impacts from objects. It would be advantageous to provide a system by which a lens is removably coupleable to the image capture devices to protect another lens of the image capture device.

### SUMMARY

Disclosed herein are implementations of housings and lens attachment systems for image capture devices.

In one implementation, a housing system for an image capture device includes a housing and a removable lens assembly. The housing is formed of an elastomeric material and defines a cavity for receiving the image capture device therein. The removable lens assembly includes a protective lens and is removably coupleable to the housing to protect a lens of the image capture device.

The housing may include a plurality of sides and a lens coupling portion formed monolithically with the plurality of sides. The lens coupling portion may be configured to receive the removable lens assembly therein to couple thereto. The coupling portion may include a rear flange and a front flange that define a circumferential channel therebetween that surrounds an optical axis of the image capture device when received in the cavity of the housing and facing radially inward toward the optical axis. The front flange of the lens coupling portion may include one or more slots recessed axially therein and extending radially outward through the lens coupling portion from a radially inner surface to a radially outer surface of the lens coupling portion radially outward of the circumferential channel. The removable lens assembly may include a lens frame that includes an outer flange and an inner flange. The outer flange may extend radially outward to be received in the circumferential channel of the housing to removably couple to the housing. The inner flange may extend radially inward and be coupled to the lens. The lens frame may include one or more protrusions that extend radially outward beyond the outer flange to be received in each of the one or more slots of the housing.

In one implementation, a housing of a housing system for an image capture device includes a plurality of sides and a lens coupling portion. The plurality of sides are formed of an elastomeric material and define a cavity for receiving the image capture device therein. The lens coupling portion is coupled to one or more of the plurality of sides. The lens coupling portion defines a circumferential channel that is open facing radially inward to receive therein a removable lens to removably couple thereto. The circumferential channel is configured to surround an optical axis of the image capture device when received in the cavity.

In one implementation, a removable lens of a housing system for an image capture device includes a lens and a lens frame. The lens frame includes an outer flange and an inner flange. The outer flange extends radially outward to be received in a housing of the housing system. The inner flange extends radially inward and is coupled to the lens.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 3 is a block diagram of electronic components of an image capture device.

FIG. 4A is an upper, front, left perspective view of a housing system for an image capture device.

FIG. 4B is a cross-sectional view of the housing system of FIG. 4A taken along line 4B-4B.

FIG. 4C is an upper, front, left perspective view of a housing of the housing system of FIG. 4A.

FIG. 4D is a cross-sectional view of the housing of FIG. 4C taken along line 4D-4D in FIG. 4C.

FIG. 4E is an upper, front, left perspective view of a removable lens of the housing system of FIG. 4A.

FIG. 4F is a cross-sectional view of the removable lens of FIG. 4E taken along line 4F-4F in FIG. 4E.

FIG. 4G is a front view of the removable lens of FIG. 4E.

FIG. 4H is a top view of the removable lens of FIG. 4E.

FIG. 5A is an upper, front, right perspective view of another housing system for an image capture device.

FIG. 5B is a cross-sectional view of the housing system of FIG. 5A taken along line 5B-5B in FIG. 5A.

FIG. 5C is an upper, front, right perspective view of a housing of the housing system of FIG. 5A.

FIG. 5D is a cross-sectional view of the housing of FIG. 5C taken along line 5D-5D in FIG. 5C.

FIG. 5E is an upper, front, right perspective view of a removable lens of the housing system of FIG. 5A.

FIG. 5F is a cross-sectional view of the removable lens of FIG. 5E taken along line 5F-5F in FIG. 5E.

FIG. 5G is a cross-sectional view of the housing system of FIG. 5A taken along line 5G-5G in FIG. 5A.

FIG. 6A is an upper, front, right perspective view of a lens attachment system for an image capture device.

FIG. 6B is a cross-sectional view of the lens attachment system of FIG. 6A taken along line 6B-6B in FIG. 6A.

FIG. 6C is an upper, front, right perspective view of a base of the lens attachment system of FIG. 6A.

FIG. 6D is a cross-sectional view of the base of FIG. 6C taken along line 6D-6D in FIG. 6C.

FIG. 6E is a lower, rear, left perspective view of the base of the lens attachment system of FIG. 6A.

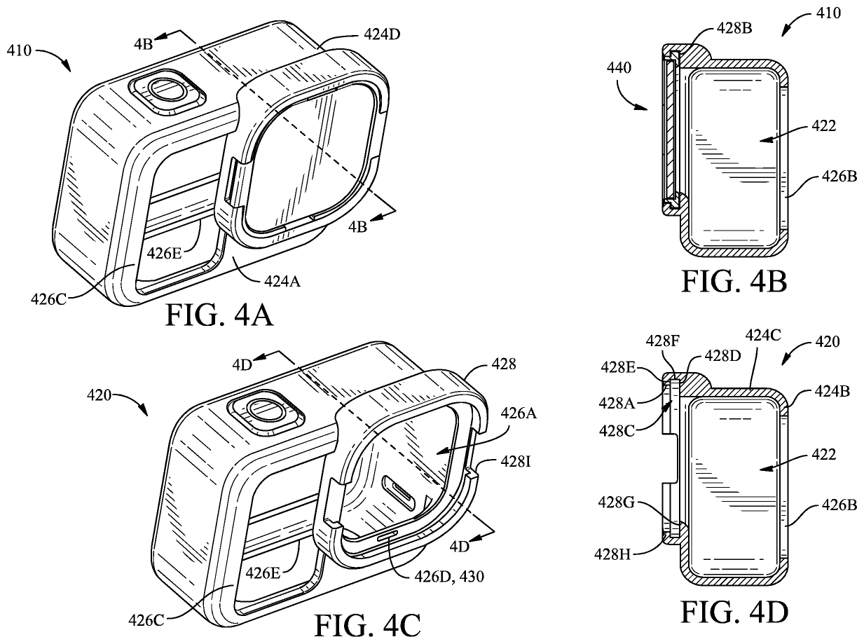

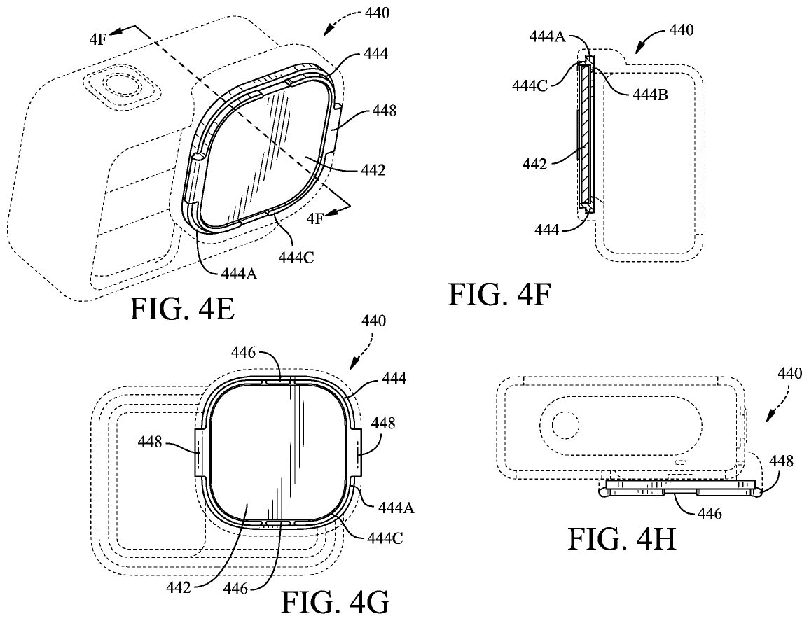

In various of FIGS. 4A-6E, features and/or components are illustrated as faded relative to other features and/or components. Such faded components are contemplated as being omitted from the drawings and/or illustrated in broken lines.

### DETAILED DESCRIPTION

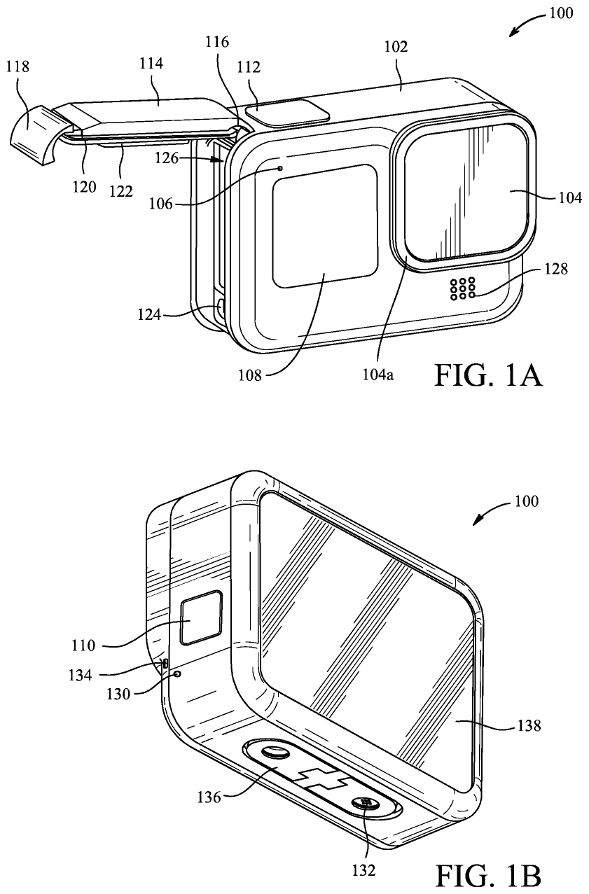

FIGS. 1A-B are perspective views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

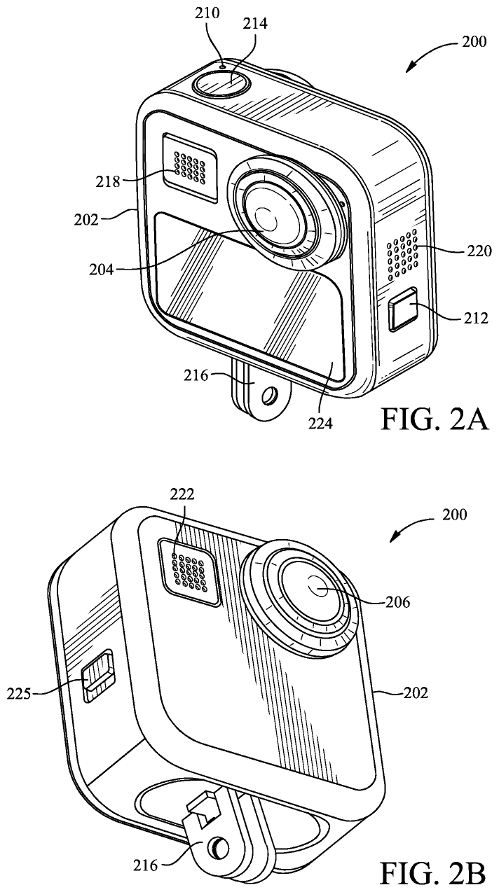

FIGS. 2A-B illustrate another example of an image capture device 200. The image capture device 200 includes a body 202 and two lenses 204 and 206 (e.g., camera lenses) disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two lenses 204 and 206 and/or perform other imaging functions.

The image capture device 200 includes various indicators, for example, LEDs 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

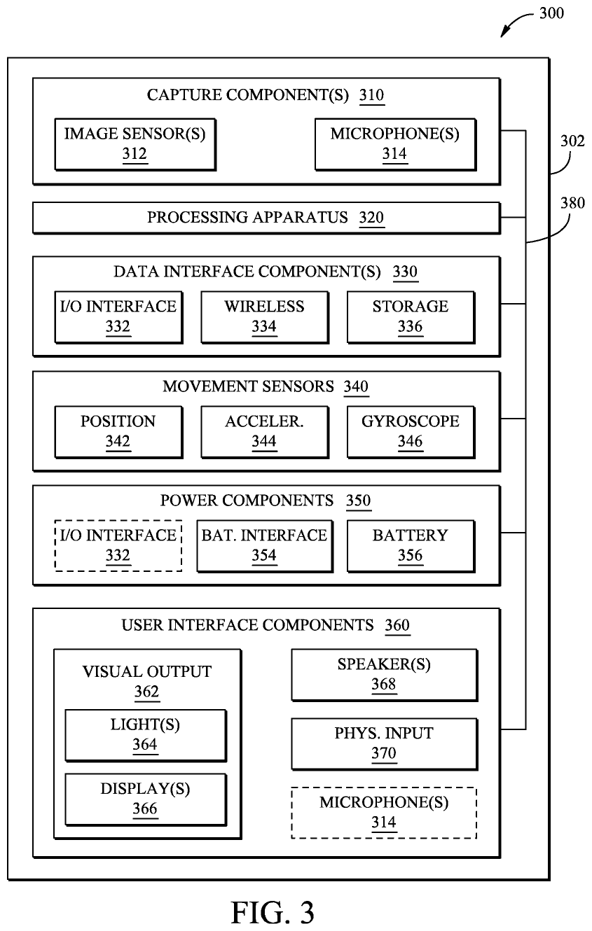

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 354 and a battery 356. The battery interface 354 operatively couples to the battery 356, for example, with conductive contacts to transfer power from the battery 356 to the other electronic components of the image capture device 300. The power components 350 may also include the I/O interface 332, and the power components 350 may receive power from an external source, such as a wall plug or external battery, for operating the image capture device 300 and/or charging the battery 356 of the image capture device 300.

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

Referring to FIGS. 4A-4H, a housing system 410 is provided for an image capture device, such as the image capture device 100 or the image capture device 200. It should be understood that, while the housing system 410 is discussed below with respect to the image capture device 100 (i.e., a single-lens image capture device), variations of the housing system 410 may be configured for use with the image capture device 200 or other multi-lens image capture device.

Referring again to FIGS. 1A and 1B, the body 102 of the image capture device 100 includes a lens bezel 104a that protrudes forward of a front side of the body 102. The body 102 of the image capture device 100 is hereafter referred to as the device body 102 to distinguish from another body (e.g., a housing) of the housing system 410, as described below. The device lens bezel 104a of the image capture device 100 is hereafter referred to as the device lens bezel 104a to distinguish from another lens bezel of the housing system 410, as described below.

The device lens bezel 104a generally surrounds the lens 104 and may further be coupled to and support the lens 104. As shown, the lens bezel and the lens 104 may be rectilinear (e.g., rectangular with rounded corners) and be positioned toward a corner of the front side of the image capture device 100. For example, as shown, the lens bezel may be biased toward an upper right corner of the front side of the body 102. Still further, an upper surface of the device lens bezel 104a may be parallel, flush, and/or coplanar with the upper surface of the body 102, and a right surface of the lens bezel may be parallel, flush, and/or coplanar with a right surface of the body 102.

The housing system 410 generally includes a housing 420 and a removable lens 440. The housing 420 is configured to receive the image capture device 100 therein, while the removable lens 440 is removably coupleable to the housing 420.

The housing 420 defines a cavity 422 for receiving and retaining the image capture device 100 therein. The housing 420, as shown, includes sides 424 that correspond to each of the sides of the image capture device 100. The sides 424 are referred to generically with reference numeral 424, though various of the sides are further described and labeled with a letter suffix (e.g., 424a). For example, the housing 420 may include six of the sides 424 (e.g., front, rear, top, bottom, left, and right), each of which include inner surfaces that define the cavity 422 and engage at least a portion of the side of the image capture device 100 corresponding thereto, so as to retain the image capture device 100 in the cavity 422. The housing 420 is, for example, made of an elastomeric material (e.g., silicone or other rubber material) that is formed monolithically (i.e., as a singular component).

The housing 420 defines various apertures 426 in the sides 424, which may provide physical access to the image capture device 100 contained therein and/or which permit light and/or sound to pass thereto. The various apertures 426 are referred to generically with reference numeral 426, though various of the apertures are further described and labeled with a letter suffix (e.g., 426a). The apertures 426 include a lens aperture 426a and a primary display aperture 426b, and may further include one or more secondary display apertures 426c, one or more sound apertures 426d, and an interconnect aperture 426e.

The lens aperture 426a is provided on a front side 424a of the sides 424 of the housing 420 and permits light to pass therethrough to the lens 104 of the image capture device 100. Further details of the lens aperture 426a are discussed in further detail below.

The primary display aperture 426b is provided on a rear side 424b of the sides 424 of the housing 420 and permits light to pass therethrough and may also provide physical access to the image capture device 100, such as to the interactive display 138. The primary display aperture 426b, thereby, provides for both viewing graphics display thereby and for providing user inputs to the interactive display 138 (e.g., for operating the image capture device 100). The primary display aperture 426b may also be sized to removably receive the image capture device 100 therethrough into the cavity 422 of the housing 420. For example, with the rear side 424b of the housing 420 engaging a rear surface of the image capture device, the primary display aperture 426b is dimensionally smaller than the rear side of the image capture device (e.g., in height and width). However, with the housing 420 being formed of an elastomeric material, the housing 420 stretches elastically to increase in size and permit the image capture device 100 to pass therethrough to be received into and removed from the cavity 422.

The one or more secondary display apertures 426c are provided on the front side 424a of the housing 420 and permit light to pass therethrough, such as for viewing output of a secondary display of the image capture device, such as the indicator 106 or the display 108 of the image capture device 100 described previously. The one or more sound apertures 426d permit sound to transfer therethrough to and/or from the one or more microphones 128, 130 and/or any speakers 132 of the image capture device 100. The interconnect aperture 426e is configured to provide physical access to the interconnect mechanism 136, or other mount, of the image capture device 100 for use thereof.

Referring again to the lens aperture 426a, the housing 420 includes a lens coupling portion 428, which defines the lens opening 426a and is configured to couple to the removable lens 440. The lens coupling portion 428 of the housing 420 corresponds to the lens 104 and the device lens bezel 104a of the image capture device 100 and, more specifically, supports the removable lens 440 to both protect the lens 104 of the image capture device 100 and permit light to pass therethrough thereto. The lens coupling portion 428 may be shaped and size for inner surfaces thereof to receive and engage or be in close proximity to outer surfaces of the device lens bezel 104a of the image capture device 100. The lens coupling portion 428 may be formed monolithically with other portions of the housing 420 (e.g., the sides 424).

In the description that follows, various components are described with rotational directional terms, such as radial and axial. As used herein, such rotational directional terms, unless specifically defined or otherwise apparent, are generally defined with respect to an optical axis of the lens 104 of the image capture device 100 and/or the removable lens 440 of the housing system 410. Thus, the term “radial” or variations thereof (e.g., “radially inner”) refer to directions outward from (e.g., generally perpendicular to) the optical axis. The term “axial” or variations thereof (e.g., “axially forward) refer to directions along (e.g., generally parallel with) the optical axis. The term “circumferential” refers to extending around the optical axis. Such rotational terms do not require circular shapes or structures (e.g., a circumferential may extend extending around the optical axis but need not be circular, instead being rectangular or otherwise shaped). The terms “front” and “rear” or variations thereof (e.g., “forward,” “rearward”) generally refer to directions extending generally along the optical axis, “front” being the side of the image capture device 100 on which the lens 104 is arranged and “forward” being the direction in which the lens 104 faces.

The lens coupling portion 428 protrudes forward of the front side 424a of the housing 420 beyond the lens 104 of the image capture device 100, so as to be coupleable to and support the removable lens 440 forward of the lens 104 of the image capture device 100. The lens coupling portion 428 includes an inner surface 428a that generally faces inward toward the optical axis and an outer surface 428b that generally faces radially outward away from the optical axis. The inner surface 428a may also be referred to as a radially inner surface, and the outer surface 428b may also be referred to as a radially outer surface. As the lens coupling portion 428 extends forward away from the image capture device 100, the inner surface 428a surrounds the device lens bezel 104a the image capture device 100 and then defines a circumferential channel 428c configured to receive therein and, thereby, couple to the removable lens 440. The inner surface 428a of the lens coupling portion 428 of the housing 420 may be spaced radially apart from the device lens bezel 104a of the device body 102 (e.g., having a larger cross-section) or may be engaged therewith. The inner surface 428a may have a rectilinear cross-sectional shape (e.g., rectangular with rounded corners) in a plane generally perpendicular to the optical axis.

The circumferential channel 428c is positioned to overlap a forward end of the device lens bezel 104a of the device body 102, such that an axial depth of the circumferential channel 428c extends axially from rearward to forward of the forward end of the lens barrel of the device body 102 and/or the lens 104. Alternatively, the circumferential channel 428c may be positioned entirely forward thereof. For example, as shown, the circumferential channel 428c is defined axially between a forward-facing surface 428d and a rearward-facing surface 428e of the inner surface 428a of the lens coupling portion 428 of the housing 420. The circumferential channel 428c is defined radially inward of an inner peripheral surface 428f of the inner surface 428a of the lens coupling portion 428 of the housing 420.

The forward-facing surface 428d of the lens coupling portion 428 extends around the device lens bezel 104a and/or the lens 104 of the image capture device 100 and, as referenced above, may be positioned rearward of the forward end of the lens barrel of the device body 102 (e.g., for the circumferential channel to overlap therewith) or may be positioned axially even or forward of the lens barrel of the device body 102 (e.g., for the circumferential channel 428c to be positioned forward of the forward thereof). The forward-facing surface 428d may be formed by a rear flange 428g (e.g., an inner or axially rearward flange) of the housing 420 that is arranged axially between the front side of the body 102 of the image capture device 100 (e.g., along lower and inward sides of the lens bezel) and may also be formed by an upper portion and an outer portion of the lens coupling portion 428 that extend axially along the sides 424 of the housing 420 (e.g., the upper side 424c and an outer side, such as the right side 424d). The forward-facing surface 428d may extend continuously around the inner surface 428a of the lens coupling portion 428, for example, being substantially planar.

The forward-facing surface 428d may also include a void 430 that, as described in further detail below, may be in communication with an aperture of the removable lens 440 to permit sound to transfer from outside the cavity 422 of the housing 420 to the image capture device 100 therein. The void 430 may be considered to be the sound aperture 426d. The void 430 may also permit moisture to escape the cavity 422 (e.g., which might otherwise be trapped between the removable lens 440 and the lens 104 of the image capture device 100. The void 430 may, for example, be formed through the rear flange 428g, such as below the device lens bezel 104a. The void 430 may also be positioned radially inward of the inner periphery of the front flange 428h. The void 430 may be an aperture that is separated from the lens aperture 426a (as shown) or may instead be a slot that protrudes outward from the lens aperture 426a.

The rearward-facing surface 428e of the lens coupling portion 428 may be formed by a front flange 428h (e.g., an axially forward flange) at a forward end of the lens coupling portion 428, which may also be referred to as a lip. The rearward-facing surface 428e is spaced apart from the forward-facing surface 428d by the inner peripheral surface 428f to define the circumferential channel 428c for receiving the removable lens 440 therebetween. An inner periphery of the front flange 428h has a smaller cross-sectional area (e.g., is radially smaller) than the outer periphery of the removable lens, such that the front flange 428h must be elastically deformed for the removable lens 440 to be received in the circumferential channel 428c. The front flange 428h may also form the forward-most surface of the lens coupling portion 428, the housing 420, and/or the housing system 410.

As shown, the front flange 428h may define slots 428i that extend from the radially from the inner surface 428a to the outer surface 428b of the lens coupling portion 428, being recessed axially relative to the forward-most surface of the lens coupling portion 428 (e.g., into the front flange 428h). The slots 428i may further extend through the inner peripheral surface 428f of the lens coupling portion 428. The slots 428i are configured to receive therein radial protrusions of the removable lens 440, which provide users physical access to an outer edge of the removable lens 440 to facilitate removal thereof, as described in further detail below. The slots 428i, along with the circumferential channel 428c, may be rotationally symmetric generally about the optical axis, thereby allowing the removable lens 440 to be received therein in two different orientations, as described below. For example, the slots 428i may be of equal size and positioned at equal heights (e.g., midway) on the outer (e.g., right) and inner (e.g., left) sides of the lens coupling portion 428. The slots 428i may also allow for the front flange 428h to be easily elastically deformed to facilitate removal and/or insertion of the removable lens 440 from the circumferential channel 428c, such that the front flange 428h is bi-furcated (e.g., into upper and lower portions that may deform independent of each other). Alternatively, the lens coupling portion 428 may be asymmetric to provide only one mounting orientation of the removable lens 440 and/or include a different number of slots 428i (e.g., none, one, or three or more).

As referenced above, the lens coupling portion 428 also includes the outer surface 428b. The outer surface 428b is spaced radially outward of the inner surface 428a, such that the lens coupling portion 428 includes sufficient material to define the features on the inner surface 428a as described above for coupling to the removable lens 440, including the circumferential channel 428c. The lens coupling portion 428 may have an outer shape (e.g., outer periphery) that is rectilinear (e.g., rectangular with rounded corners).

The removable lens 440 is configured to removably couple to the housing 420 of the housing system 410 and, in particular, be received in the circumferential channel 428c of the lens coupling portion 428. The removable lens 440 generally includes a lens 442 and a lens frame 444 and may also be referred to as a lens frame assembly. The lens 442 is configured to protect the lens 104 of the image capture device 100 and may be referred to as a protective lens. The lens 442 is formed of a transparent material configured for light to transfer therethrough, so as to pass through the lens aperture 426a of the housing 420 to the lens 104 of the image capture device 100. The lens 442 may have a rectilinear shape, for example, being rectangular with rounded corners. In some embodiments, the lens frame 444 may be omitted, such that the lens 442 is received directly by the lens coupling portion 428 of the housing 420.

The lens frame 444 is coupled to the lens 442 and, in turn, is configured to removably couple to the housing 420 and, more specifically, be received in the circumferential channel 428c of the lens coupling portion 428. The lens frame 444 generally includes an outer flange 444a and an inner flange 444b, and may further include a forward-extending flange 444c.

The outer flange 444a extends radially outward to form an outer periphery of the removable lens 440 that is to be received by and, thereby, coupled to the housing 420. The outer flange 444a may also be referred to as a radially-outer flange. The outer flange 444a is shaped and sized to be received in the circumferential channel 428c of the lens coupling portion 428 for coupling the removable lens 440 thereto. The outer flange 444a has a shape that generally corresponds to the front flange 428h and the circumferential channel 428c, for example, being rectilinear (e.g., being rectangular with rounded corners). The outer flange 444a is also sized to be received and retained in the circumferential channel 428c. The outer flange 444a is larger (e.g., width and height) than the inner periphery of the front flange 428h, while being approximately the same size or smaller (e.g., width and height) than the inner peripheral surface 428f. The outer flange 444a may also have approximately the same or smaller axial dimension (e.g., thickness) than the axial depth of the circumferential channel 428c (i.e., between the forward-facing surface 428d and the rearward-facing surface 428e, which may be equal to the axial dimension of the inner peripheral surface 428f). Thereby, the outer flange 444a of the lens frame 444 may be received and retained (e.g., being engaged by) to the lens coupling portion 428 and in a generally static and pre-defined orientation relative to the lens 104 of the image capture device 100.

The inner flange 444b is coupled to the lens 442. More particularly, the inner flange 444b is shaped and sized for a forward surface thereof to be coupled (e.g., adhered) to an outer periphery of a rearward surface of the lens 442, for example, extending radially inward a uniform dimension from an outer edge of the lens 442 to an inner periphery thereof. The inner flange 444b may also be shaped and sized to receive the forward end of the device lens bezel 104a therein. For example, the inner periphery of the inner flange 444b may rectilinear (e.g., rectangular with rounded corners) and be slightly larger (e.g., width and height) than the forward end of the device lens bezel 104a. The outer flange 444a and the inner flange 444b may have the same thickness and/or be positioned at a common axial position, thereby being considered to cooperatively form a rearward portion of the lens frame 444. With the lens 442 being coupled to the forward surface of the inner flange 444b, the thickness of the inner flange 444b may permit receipt of the forward end of the device lens bezel 104a partially therein. If a user were to instead face the lens 442 rearward while trying to insert the outer flange 444a into the circumferential channel 428c of the lens coupling portion 428, the lens 442 may engage the forward end of the device lens bezel 104a and prevent insertion of the outer flange 444a into the circumferential channel 428c and, thereby, prevent coupling of the removable lens 440 to the housing 420 when orientation incorrectly (i.e., facing the wrong direction)

The forward-extending flange 444c extends axially forward from the inner flange 444b. The forward-extending flange 444c is shaped and sized to define a recess in which the lens 442 is positioned and may be further be shaped and sized to locate the lens 442 in a predetermined spatial relationship relative to the lens frame 444 during assembly of the removable lens 440. For example, an inner periphery of the forward-extending flange 444c have substantially the same shape (e.g., being rectilinear, such as rectangular with rounded corners) and be slightly larger than the lens 442 to receive and locate the lens 442 therein. The inner periphery of the forward-extending flange 444c is larger than the inner flange 444b that, for example, extends radially inward from the forward-extending flange 444c a uniform dimension around the periphery thereof.

The forward-extending flange 444c has an outer periphery that is smaller than the outer periphery of the outer flange 444a, for example, with the outer flange 444a extending radially outward relative to (e.g., from) the forward-extending flange 444c a uniform dimension therearound (e.g., around a majority thereof). For example, the outer periphery of the forward-extending flange 444c may be shaped and sized substantially equal to an inner periphery of the front flange 428h of the lens coupling portion 428, which is engaged thereby to locate the removable lens 440 in a predetermined position relative to the lens coupling portion 428 and, thereby, the lens 104 of the image capture device 100. The forward-extending flange 444c may extend axially forward of the outer flange 444a a distance substantially equal to the thickness of the front flange 428h of the lens coupling portion 428, such that forward surfaces of the lens frame 444 and the lens coupling portion 428 are substantially flush. The forward-extending flange 444c may be considered to form a forward portion of the lens frame 444.

The lens frame 444 may also define one or more voids 446 extending axially therethrough, which as referenced above, may be aligned with the void 430 that is arranged inside the lens coupling portion 428 when the removable lens 440 is coupled to the housing 420. The void 446 may be configured as an aperture (as shown) that is continuously surround by material of the lens frame 444 or may be a slot that is partially surrounded by material of the lens frame 444. Each of the one or more voids 446 is positioned at least partially radially outward of the lens 442, such as entirely radially outward (as shown). For example, each of the voids 446 may extend through the forward portion of the lens frame 444 (e.g., being a slot in the forward-extending flange 444c) and through the rear portion (e.g., being positioned between the outer flange 444a and the inner flange 444b). The voids 446 may be rotationally symmetric, for example, with one of the voids 446 being positioned at an upper side of the lens frame 444 (i.e., above the lens 442) and another of the voids 446 being positioned at a lower side of the lens frame 444 (i.e., below the lens), both of which may be centered relative to left and right sides of the lens frame 444. While the lens frame 444 may include two or more of the voids 446, the housing 420 may include only one of the voids 430 corresponding thereto, such that only one of the voids 446 is in communication with the void 430. The other of the two voids 446 may be positioned against the forward-facing surface 428d of the inner surface 428a of the lens coupling portion 428.

The lens frame 444 may also include one or more radial protrusions 448, which extend radially outward of the outer flange 444a. Each of the one or more radial protrusions 448, as referenced above, correspond to the slots 428i of the lens coupling portion 428 to be received therein. The radial protrusion 448 extends radially outward in the slot 428i, for example, being coextensive with the outer surface 428b of the lens coupling portion 428 adjacent thereto, or may extend therebeyond. In each case, radially outer ends of the radial protrusions 448 are exposed to allow the user to remove the removable lens 440 from the housing 420 by pulling the outer flange 444a of the lens frame 444 from the circumferential channel 428c of the lens coupling portion 428. The radial protrusion 448 may extend axially forward of the outer flange 444a a distance approximately equal to a thickness of the front flange 428h, for example having the same thickness, such that the forward surfaces thereof are substantially flush, such as coplanar. The radial protrusions 448 may be considered part of the forward portion of the lens frame 444.

The radial protrusions 448 may be rotationally symmetric, for example, with one of the radial protrusions 448 being positioned at an outer side (i.e., the right side) and another of the radial protrusions 448 being positioned at an inner side of the lens frame 444 (e.g., the left side) relative to the device lens bezel 104a (i.e., left of the lens 104), both of which may be centered relative to upper and lower sides of the lens frame 444. As a result, removable lens 440 may be coupleable to the housing 420 in two different orientations, which are rotated about the axial direction 180 degrees.

The lens frame 444 may, for example, be formed of a polymer material, such as injection molded plastic, or a metal, such as aluminum.

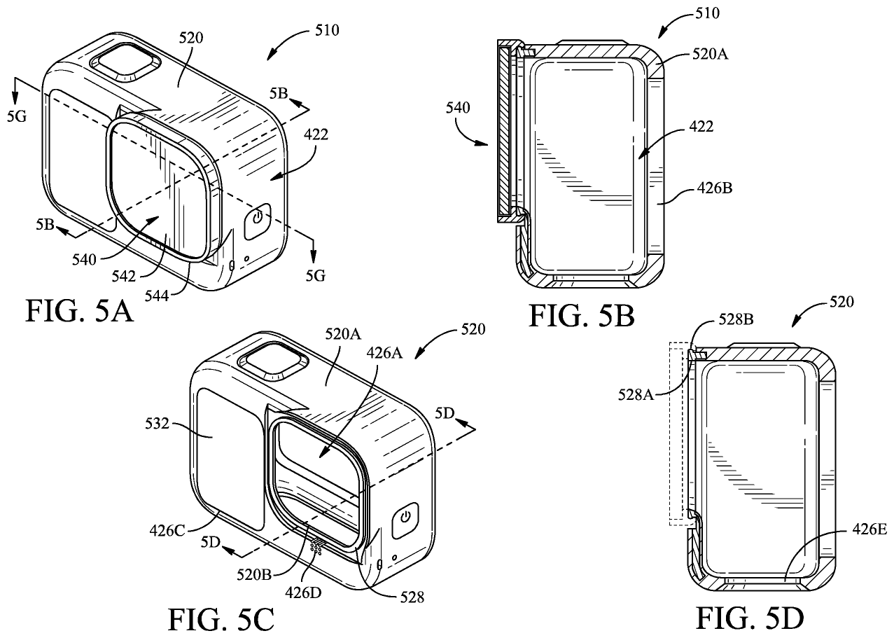

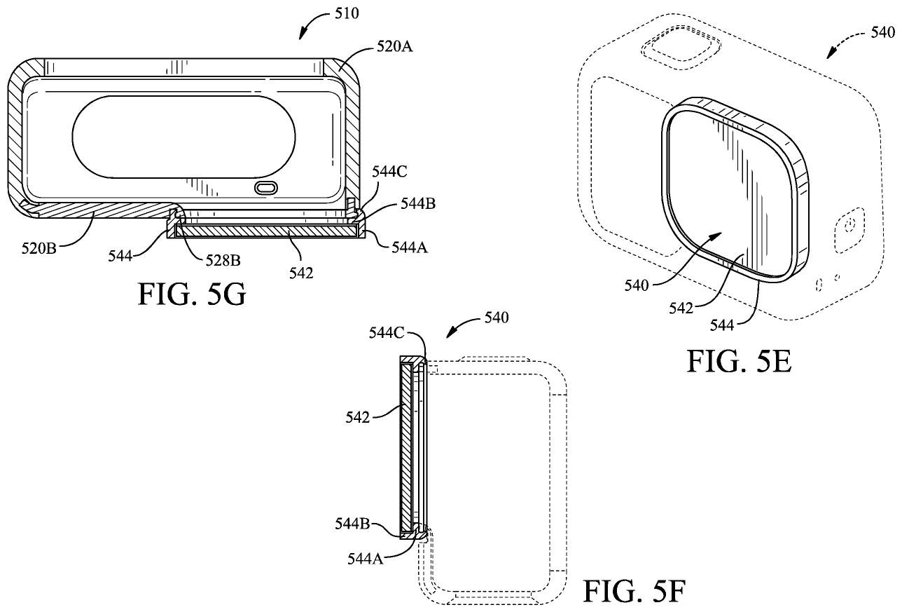

Referring to FIGS. 5A-5G, a housing system 510 is a variation of the housing system 410. The housing system 510 generally includes a housing 520 and a removable lens assembly 540. Rather than the lens coupling portion 428 being formed of an elastomer continuously with the housing 420 and the removable lens 440 being received therein, the housing 520 includes a lens coupling portion 528 that is formed of a rigid material that is coupled to the housing 520 formed of an elastomeric material, and the removable lens assembly 540 instead receives the lens coupling portion 528 therein to be coupled thereto. Furthermore, the secondary display aperture 426c may be closed with a rigid, transparent material that forms a window 532, which may protect the display 108 thereunder.

The housing 520 generally includes a flexible body portion 520a and a rigid body portion 520b. The flexible body portion 520a is configured similar to the housing 420 with various like features. For example, the housing 520 generally includes the cavity 422, the sides 424 (e.g., front, back, top, bottom, left, and right), and various of the apertures 426 (e.g., the primary display aperture 426b, the secondary display aperture 426c, the sound apertures 426d, the interconnect aperture 426e, and/or the drain apertures). The flexible body portion 520a is formed of a flexible material, such as an elastomeric material, such as silicone, as described above for the housing 420.

The rigid body portion 520b is formed of a rigid material, such as a transparent plastic material. The rigid body portion 520b generally forms a window 532 that substantially closes the secondary display aperture 426c and is aligned with the display 108 of the image capture device 100, thereby allowing user to see graphics output by the display 108, while also protecting the display 108 therebehind.

The rigid body portion 520b further includes the lens coupling portion 528 that is configured to couple to a removable lens assembly 540. The lens coupling portion 528 defines the lens aperture 426a through which light passes to the lens 104 of the image capture device 100. For example, lens coupling portion 528 includes an inner surface 528a (e.g., facing radially inward) with a rectilinear cross-sectional shape (e.g., rectangular with rounded corners) and that surrounds the device lens bezel 104a. The inner surface 528a may also be referred to as a radially inner surface. The lens coupling portion 528 further includes an outer flange 528b that protrudes radially outward relative to the inner surface 528a and is configured to receive therebehind a corresponding inwardly-protruding flange of the removable lens assembly 540, as described below. The outer flange 528b may also be referred to as a radially outer flange. The outer flange 528b may extend substantially continuously around an outer periphery of the device lens bezel 104a.

The rigid body portion 520b may be a singular component, such as an injection molded transparent plastic, which is overmolded by the flexible material, such as an elastomer or silicon, forming the flexible body portion 520a to be coupled thereto. While the window 532 and lens coupling portion 528 are described as a singular component, they may instead be provided as separate components that are separately coupled to the flexible body portion 520a of the housing 520.

The removable lens assembly 540 generally includes a lens 542 and a lens frame 544. The lens 542 may be as described above and coupled to the lens frame 544, such as with an adhesive.

The lens frame 544 generally includes an inner flange 544a, a forward-extending flange 544b, and a coupling flange 544c. The inner flange 544a is configured similar to the inner flange 444b of the lens frame 444, for example, by extending radially inward, engaging, and coupling to an outer periphery of a rear surface of the lens 542. The inner flange 544a may also be referred to as a radially inner flange. The inner flange 544a also includes an inner periphery that defines an aperture through which light passes to the lens 104 of the image capture device 100. The inner periphery of the inner flange 544a may have a cross-sectional shape that is rectilinear, for example, being rectangular with rounded corners.

The forward-extending flange 544b is configured similar to the forward-extending flange 444c, for example, by being configured to receive and locate that lens 542 and by extending forward from the inner flange 544a.

The coupling flange 544c is configured to couple the removable lens assembly 540 to the housing 520 and, in particular, to the lens coupling portion 528. The coupling flange 544c extends rearward of the inner flange 544a and protrudes radially inward toward the lens aperture 426a. The coupling flange 544c defines an inner periphery that is smaller than the outer periphery of the outer flange 528b of lens coupling portion 528, so as to be receivable therebehind to couple the removable lens assembly 540 thereto. Furthermore, the coupling flange 544c may be spaced rearward of the inner flange 544a, thereby defining a circumferential channel in which is received the outer flange 528b of the lens coupling portion 528. Moreover, the coupling flange 544c and the inner flange 544a may engage forward and rearward surfaces of the outer flange 528b of lens coupling portion 528, respectively, so as to axially locate the removable lens assembly 540 relative to the housing 520.

Thus, each of the housing systems 410, 510 include a housing (i.e., 420, 520) and a removable lens assembly (i.e., 440, 540) that is removably coupleable to the housing with a circumferential channel of one of the housing or the removable lens assembly and a circumferential flange of the other of the housing or the removable lens assembly that is received in the circumferential channel. The circumferential channel and the circumferential flange may be features of the housing and the removable lens assembly, respectively, as provided with the housing system 410, or vice versa as in the housing system 510.

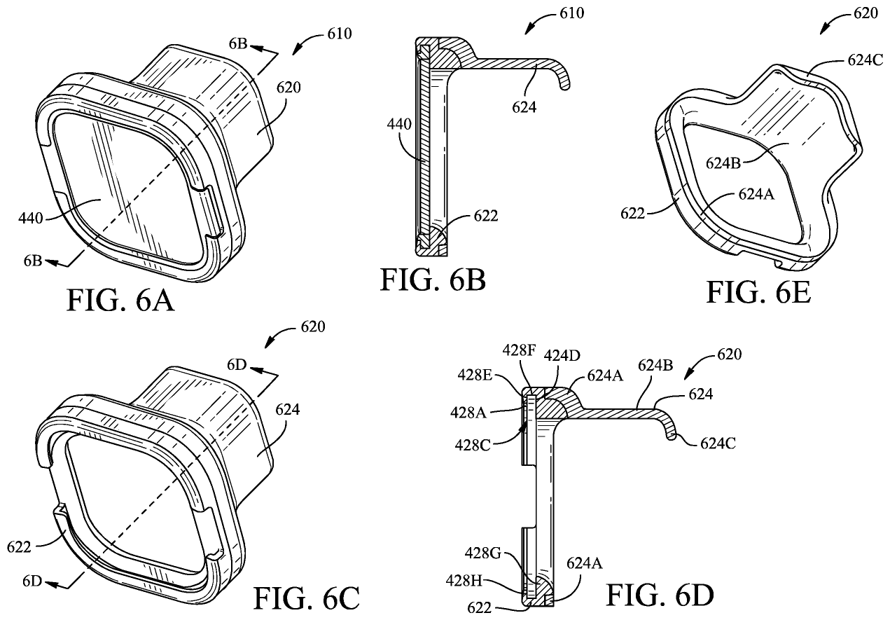

Referring to FIGS. 6A-6E, a lens attachment system 610 generally includes a base 620 and a removable lens assembly, which may be there removable lens 440 (as shown) or the removable lens assembly 540. The base 620 is configured to removably couple to the image capture device 100, while the removable lens 440 is removably coupleable to base 620 and, thereby, indirectly removably coupleable to the image capture device 100.

The base 620 generally includes a lens coupling portion 622 and a device coupling portion 624 (e.g., chassis). The device coupling portion 624 is configured to engage and, thereby, removably couple to the image capture device 100.

The lens coupling portion 622 may be configured to couple to the removable lens 440, described previously, in substantially the same manner as the lens coupling portion 428, described previously. For example, the lens coupling portion 622 may be formed of an elastomeric material (e.g., silicone), generally surround the device lens bezel 104a, and include the inner surface 428a that defines the circumferential channel 428c (i.e., between the rear flange 428g (e.g., the shelf) and the front flange 428h (e.g., the lip)). The lens coupling portion 622 may further include the one or more slots 428i for receiving the radial protrusions 448 of the lens frame 444. The lens coupling portion622 may be considered to form a forward portion of the base 620, and may be formed of a different material from the device coupling portion 624.

The device coupling portion 624, which may also be referred to as a chassis, may be formed of a rigid material generally includes a forward portion 624a, a middle portion 624b, and a rear portion 624c. The forward portion 624a is coupled to the lens coupling portion 622. The forward portion 624a may, for example, circumscribe the device lens bezel 104a and a rear portion 624c of the lens coupling portion 622 therebehind. For example, a rear surface of the forward portion 624a may be positioned against the front surface of the body 102 of the image capture device, while a rear portion of the lens coupling portion 622 (i.e., rearward of the rear flange 428g) engages the peripheral sides of the device lens bezel 104a that face radial directions and may further engage upper and/or outer sides of the body 102. The lens coupling portion 622 and the forward portion 624a of the base 620 may be considered to form a lens bezel (e.g., a base lens bezel) and/or the forward portion of the base 620. The lens coupling portion 622 may be coupled to the forward portion 624a of the device coupling portion 624 by being overmolded thereto (e.g., elastomer being molded over a plastic).

The middle portion 624b of the device coupling portion extends rearward from the forward portion 624a (e.g., from the base lens bezel) to the rear portion 624c. The middle portion 624b may instead be referred to as an extension or extension portion of the device coupling portion 624. The middle portion 624b extends along one, the other, or both of the upper side or an outer side (e.g., the right side) of the body 102 to the rear portion 624c.

The rear portion 624c is configured as a hook (e.g., a flange) that extends inward behind and in engagement with the rear side of the body 102 of the image capture device 100. For example, the rear portion 624c may engage a rearward-facing surface of a bezel of the body 102 that surrounds the interactive display 138 on the rear side of the image capture device 100, and may further extend forward into a recess defined by the bezel of the body 102.

When the lens attachment system 610 is coupled to the image capture device, the lens attachment system 610 is held in place radially and axially. The device lens bezel 104a is positioned in the base lens bezel of the device coupling portion 624 (i.e., formed by the lens coupling portion 622 and the forward portion 624a of the device coupling portion 624) and is circumferentially surrounded and radially engaged thereby, so as to prevent translational movement in the radial directions of the lens attachment system 610 relative to the body 102 of the image capture device 100. The base lens bezel may be considered to be hooked around the device lens bezel 104a of the image capture device 100. The body 102 of the image capture device 100 is also positioned axially between and axially engaged by the device lens bezel (e.g., the rear surface of the forward portion 624a of the device coupling portion 624) and the rear portion 624c of the device coupling portion 624 (e.g., a forward surface thereof). To insert or remove the body 102 (e.g., including the device lens bezel 104a) of the image capture device 100 from the lens attachment system 610, the device coupling portion 624 may elastically flex (e.g., the middle portion 624b and/or the rear portion 624c relative to each other and/or the forward portion 624a).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A housing system for an image capture device comprising:
a housing formed of an elastomeric material and defining a cavity for receiving an image capture device therein; and
a removable lens assembly that includes a protective lens and is removably coupleable to the housing to protect a lens of the image capture device.

2. The housing system according to claim 1, wherein the housing includes a plurality of sides and a lens coupling portion formed monolithically with the plurality of sides
wherein the lens coupling portion configured to receive the removable lens assembly therein to couple thereto, the lens coupling portion including a rear flange and a front flange that define a circumferential channel therebetween that surrounds an optical axis of the image capture device when received in the cavity of the housing and facing radially inward toward the optical axis;
wherein the front flange of the lens coupling portion includes one or more slots recessed axially therein extending radially outward through the lens coupling portion from a radially inner surface to a radially outer surface of the lens coupling portion radially outward of the circumferential channel;
wherein the removable lens assembly includes a lens frame that includes an outer flange and an inner flange, the outer flange extending radially outward to be received in the circumferential channel of the housing to removably couple to the housing, and the inner flange extending radially inward and being coupled to the protective lens; and
wherein the lens frame includes one or more protrusions that extend radially outward beyond the outer flange to be received in each of the one or more slots of the housing.

3. The housing system according to claim 1, wherein the housing includes a lens coupling portion cooperatively configured with the removable lens assembly to receive therein the removable lens assembly to removably couple to the lens coupling portion.

4. The housing system according to claim 3, wherein the lens coupling portion defines a circumferential channel, the circumferential channel being configured to surround an optical axis of the image capture device when received in the cavity of the housing and facing radially inward toward the optical axis; and
wherein the removable lens assembly includes a lens frame that is coupled to the protective lens and that includes an outer flange that extends radially outward and is receivable in the circumferential channel to removably couple the removable lens assembly to the lens coupling portion.

5. The housing system according to claim 4, wherein the lens coupling portion includes a rear flange and a front flange that define therebetween the circumferential channel.

6. The housing system according to claim 5, wherein the rear flange of the lens coupling portion of the housing includes a first void, and the lens frame includes a second void that, when the removable lens assembly is coupled to the lens coupling portion, is aligned with the first void to form a passage for sound to transfer into the cavity to a microphone of the image capture device therein.

7. The housing system according to claim 5, wherein the front flange of the lens coupling portion includes one or more slots recessed axially therein extending radially outward through the lens coupling portion from a radially inner surface to a radially outer surface of the lens coupling portion radially outward, and the removable lens assembly includes one or more protrusions that are receivable in the one or more slots.

8. The housing system according to claim 5, wherein the housing includes a plurality of sides that define the cavity therebetween, and the lens coupling portion is monolithic with the plurality of sides.

9. The housing system according to claim 1, wherein the housing includes a lens coupling portion cooperatively configured with the removable lens assembly to receive therearound the removable lens assembly to removably couple to the lens coupling portion.

10. The housing system according to claim 1, wherein the removable lens assembly includes a lens frame that includes an outer flange and an inner flange, the outer flange extending radially outward to be received by the housing to removably couple to the housing, and the inner flange extending radially inward and being coupled to the protective lens.

11. The housing system according to claim 10, wherein the lens frame includes one or more protrusions that extend radially outward beyond the outer flange to be received in one or more corresponding slots of the housing.

12. The housing system according to claim 10, wherein the lens frame defines a void extending axially therethrough and positioned radially outward of the protective lens, the void being configured to, when the removable lens assembly is coupled to the housing, permit sound waves to transfer substantially unobstructed therethrough to a microphone of the image capture device in the cavity of the housing.

13. The housing system according to claim 11, wherein the removable lens assembly is rotationally symmetric, the housing and the removable lens assembly being cooperatively configured for the removable lens assembly to removably couple to the housing in only two predetermined orientations.

14. The housing system according to claim 13, wherein the housing defines a void, and the lens frame defines two corresponding voids extending therethrough, wherein only one of the two corresponding voids is aligned with the void in each of the two predetermined orientations to permit sound waves to travel substantially unobstructed therethrough to a microphone of the image capture device in the cavity of the housing.

15. A housing of a housing system for an image capture device comprising:
a plurality of sides formed of an elastomeric material and defining a cavity for receiving an image capture device therein; and
a lens coupling portion coupled to one or more of the plurality of sides and defining a circumferential channel that is open facing radially inward to receive therein a removable lens to removably couple thereto, the circumferential channel being configured to surround an optical axis of the image capture device when received in the cavity.

16. The housing according to claim 15, wherein the lens coupling portion includes a rear flange and a front flange that define therebetween the circumferential channel;
wherein the rear flange of the lens coupling portion of the housing includes a passage extending axially therethrough for sound to transfer into the cavity to a microphone of the image capture device therein; and
wherein the front flange of the lens coupling portion includes one or more slots extending from a radially inner surface to a radially outer surface of the lens coupling portion to be radially outward of the circumferential channel for receiving one or more protrusions of the removable lens.

17. The housing according to claim 15, wherein the lens coupling portion is monolithic with the plurality of sides.

18. A removable lens of a housing system for an image capture device, the removable lens comprising:
a lens;
a lens frame that includes an outer flange and an inner flange, the outer flange extending radially outward to be received in a housing of the housing system, and the inner flange being coupled to the lens.

19. The removable lens according to claim 18, wherein the lens frame includes one or more protrusions that extend radially outward beyond the outer flange and are receivable in one or more corresponding slots of the housing; and
wherein the lens frame defines a void extending axially therethrough and positioned radially outward of the lens, the void being configured to permit sound waves to transfer substantially unobstructed therethrough to a microphone of the image capture device contained in the housing.

20. The removable lens according to claim 18, wherein the removable lens is rotationally symmetric and configured to removably couple to the housing in only two predetermined orientations.
